(19) United States
(12) Patent Application Publication
(10) Pub. No.: US 2025/0276687 A1
(43) Pub. Date: Sep. 4, 2025

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Takahiro Shimizu, Tokyo (JP); Sho Tamura, Tokyo (JP)

(21) Appl. No.: 19/063,407

(22) Filed: Feb. 26, 2025

(30) Foreign Application Priority Data
Mar. 4, 2024 (JP) 2024-032028

(51) Int. Cl. B60W 30/10; B60W 60/00

(52) U.S. Cl. CPC B60W 30/10; B60W 60/001

(57) ABSTRACT

A vehicle control device including: a storage medium storing instructions that are able to be read by a computer; and a processor connected to the storage medium, in which, by executing instructions that are able to be read by the computer, the processor: judges whether or not an “S”-shaped road candidate that is a partition represented by map road partition lines based on map information stored in a storage unit represents an “S”-shaped road; and performs traveling control of a vehicle on the basis of the map road partition lines, the processor judges that the “S”-shaped road candidate is not an “S” shaped road in a case in which a distance between a start point and an end point of the “S”-shaped road candidate is a first threshold or less, and the processor inhibits traveling control of the vehicle corresponding to a curved road in a case in which it is judged that the “S”-shaped road candidate is not an “S”-shaped road.

### CROSS-REFERENCE TO RELATED APPLICATION

Priority is claimed on Japanese Patent Application No. 2024-032028, filed on Mar. 4, 2024, the contents of which are incorporated herein by reference.

### BACKGROUND

### Field of the Invention

The present invention relates to a vehicle control device, a vehicle control method, and a storage medium.

### Description of Related Art

In recent years, efforts to provide access to sustainable transportation systems that also take the vulnerable among transportation participants into account have been made. Toward realization of this, research and development for further improving safety and convenience of traffic through research and development relating to automated driving technology has been focused upon.

Incidentally, in automated driving technologies, although coincidence between road partition lines recognized from a camera image and road partition lines recognized from map information is checked and is used for generation of a target locus of a subject vehicle, there is a problem that misrecognition may easily occur in these road partition lines. In order to deal with this problem, for example, it is disclosed in Japanese Unexamined Patent Application Publication No. 2017-068617 that, in a case in which the location of a subject vehicle is present in a section of a branching road, image recognition of the branch side is restricted. In addition, Japanese Unexamined Patent Application Publication No. 2018-200501 discloses that, in a case in which an evaluation of continuity between an actual boundary acquired from a recognition range before/after the subject vehicle during traveling in a curved road and a map boundary is high, these are integrated as information and are used, and, in a case in which the evaluation is low, the map boundary is used.

However, all of these conventional technologies deal with misrecognition of road partition lines in specific sections such as a branching road and a curved road. On the other hand, also in a case in which a subject vehicle travels on a general straight road, misrecognition may occur in road partition lines. For example, there is a case in which misrecognition occurs in road partition lines recognized from map information, and a road partition line which should be recognized as that of a straight road is recognized as that of an “S”-shaped curved road while a subject vehicle is traveling on a straight road. As a result, there is a case in which traveling control according to a curved road is applied to a subject vehicle traveling using automated driving or drive assistance, and, even when the subject vehicle is traveling on a straight road, for example, inappropriate deceleration control is executed.

### SUMMARY

The present invention is in consideration of such situations, and one object thereof is to provide a vehicle control device, a vehicle control method, and a storage medium capable of preventing execution of inappropriate traveling control in a subject vehicle due to misrecognition of road partition lines recognized from map information as an “S”-shaped curved road. Furthermore, the present invention contributes to development of a sustainable transportation system.

A vehicle control device according to the present invention employs the following configurations.

(1): According to one aspect of the present invention, there is provided a vehicle control device including: a storage medium storing instructions that are able to be read by a computer; and a processor connected to the storage medium, in which, by executing instructions that are able to be read by the computer, the processor: judges whether or not an “S”-shaped road candidate that is a partition represented by map road partition lines based on map information stored in a storage unit represents an “S”-shaped road; and performs traveling control of a vehicle on the basis of the map road partition lines, the processor judges that the “S”-shaped road candidate is not an “S” shaped road in a case in which a distance between a start point and an end point of the “S”-shaped road candidate is a first threshold or less, and the processor inhibits traveling control of the vehicle corresponding to a curved road in a case in which it is judged that the “S”-shaped road candidate is not an “S”-shaped road.

(2): In the aspect (1) described above, the processor judges that the “S”-shaped road candidate is not an “S”-shaped road in a case in which the distance between the start point and the end point of the “S”-shaped road candidate is the first threshold or less, and an amount of curvature change of at least one of a front range and a rear range of the “S”-shaped road candidate is a second threshold or less.

(3): In the aspect (1) described above, the processor judges that the “S”-shaped road candidate is not an “S”-shaped road in a case in which the distance between the start point and the end point of the “S”-shaped road candidate is the first threshold or less, and at least one of a front range and a rear range of the “S”-shaped road candidate is a straight line.

(4): In the aspect (1) described above, the processor performs traveling control such that the vehicle goes straight in a case in which it is judged that the “S”-shaped road candidate is not an “S”-shaped road.

(5): In the aspect (1) described above, in a case in which it is judged that the “S”-shaped road candidate is not an “S”-shaped road, the processor continues the traveling control that has been performed before the judgment.

(6): In the aspect (1) described above, in a case in which it is judged that the “S”-shaped road candidate is not an “S”-shaped road, the processor performs traveling control corresponding to the end point of the “S”-shaped road candidate or a start point of a road following the “S”-shaped road candidate.

(7): In the aspect (1) described above, in a case in which it is judged that the “S”-shaped road candidate is not an “S”-shaped road, the processor does not execute curved-road deceleration control for the “S”-shaped road candidate.

(8): According to another aspect of the present invention, there is provided a vehicle control method using a computer, the vehicle control method including: judging whether or not an “S”-shaped road candidate that is a partition represented by map road partition lines based on map information stored in a storage unit represents an “S”-shaped road; performing traveling control of a vehicle on the basis of the map road partition lines; judging that the “S”-shaped road candidate is not an “S” shaped road in a case in which a distance between a start point and an end point of the “S”-shaped road candidate is a first threshold or less, and inhibiting traveling control of the vehicle corresponding to a curved road in a case in which it is judged that the “S”-shaped road candidate is not an “S”-shaped road.

(9): According to another aspect of the present invention, there is provided a computer-readable non-transitory storage medium storing a program causing a computer to: judge whether or not an “S”-shaped road candidate that is a partition represented by map road partition lines based on map information stored in a storage unit represents an “S”-shaped road; perform traveling control of a vehicle on the basis of the map road partition lines; judge that the “S”-shaped road candidate is not an “S” shaped road in a case in which a distance between a start point and an end point of the “S”-shaped road candidate is a first threshold or less, and inhibit traveling control of the vehicle corresponding to a curved road in a case in which it is judged that the “S”-shaped road candidate is not an “S”-shaped road.

According to the aspects (1) to (9) described above, execution of inappropriate traveling control in a subject vehicle due to misrecognition of road partition lines recognized from map information as an “S”-shaped curved road can be prevented.

### BRIEF DESCRIPTION OF THE DRAWINGS

FIG. 1 is a configuration diagram of a vehicle system using a vehicle control device according to an embodiment.

FIG. 2 is a functional configuration diagram of a first control unit and a second control unit.

FIG. 3 is a diagram illustrating one example of a correspondence relation of a drive mode, a control state of a subject vehicle, and a task.

FIG. 4 is a diagram illustrating conditions for a judgment unit to extract an “S”-shaped curved road candidate.

FIG. 5 is a diagram illustrating a method of judging an “S”-shaped curved road candidate as noise using the judgment unit.

FIG. 6 is a diagram illustrating a method of normally judging an “S”-shaped curved road candidate as an “S”-shaped curved road using the judgment unit.

FIG. 7 is a flowchart illustrating one example of the flow of a process executed by an automated driving control device.

### DESCRIPTION OF EMBODIMENTS

Hereinafter, a vehicle control device, a vehicle control method, and a storage medium according to an embodiment of the present invention will be described with reference to the drawings.

### [Entire Configuration]

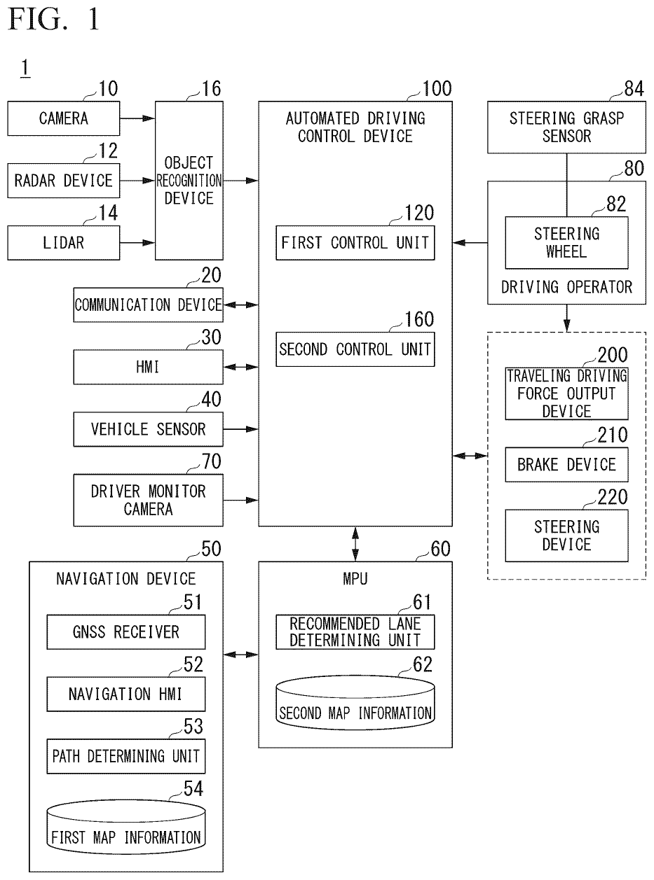

FIG. 1 is a configuration diagram of a vehicle system 1 using a vehicle control device according to an embodiment. A vehicle in which the vehicle system 1 is mounted is, for example, a vehicle having two wheels, three wheels, four wheels, or the like, and a driving source thereof is an internal combustion engine such as a diesel engine or a gasoline engine, an electric motor, or a combination thereof. The electric motor operates using power generated using a power generator connected to an internal combustion engine or discharge power of a secondary cell or a fuel cell.

For example, the vehicle system 1 includes a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driver monitor camera 70, a driving operator 80, an automated driving control device 100, a traveling driving force output device 200, a brake device 210, and a steering device 220. Such devices and units are mutually connected using a multiplexing communication line such as a controller area network (CAN) communication line, a serial communication line, a radio communication network, or the like. The configuration illustrated in FIG. 1 is merely an example, and a part of the configuration may be omitted, and an additional configuration may be further added.

The camera 10, for example, is a digital camera using a solid-state imaging device such as a charge coupled device (CCD) or a complementary metal oxide semiconductor (CMOS). The camera 10 is mounted at an arbitrary place in a vehicle (hereinafter, a subject vehicle M) in which the vehicle system 1 is mounted. In a case in which a side in front is to be imaged, the camera 10 is mounted in an upper part of a front windshield, a rear face of a room mirror, or the like. The camera 10, for example, periodically images the vicinity of the subject vehicle M repeatedly. The camera 10 may be a stereo camera.

The radar device 12 emits radio waves such as millimeter waves to the vicinity of the subject vehicle M and detects at least a position of (a distance and an azimuth) a target object by detecting radio waves (reflected waves) reflected by the object. The radar device 12 is mounted at an arbitrary place on the subject vehicle M. The radar device 12 may detect a position and a speed of an object using a frequency modulated continuous wave (FM-CW) system.

The LIDAR 14 emits light (or a radiowave having a wavelength close to light) to the vicinity of the subject vehicle M and measures scattered light. The LIDAR 14 detects a distance to a target on the basis of a time from light emission to light reception. For example, the emitted light is pulse-shaped laser light. The LIDAR 14 is mounted at an arbitrary place in the subject vehicle M.

The object recognition device 16 performs a sensor fusion process for detection results acquired using some or all of the camera 10, the radar device 12, and the LIDARs 14, thereby recognizing a position, a type, a speed, and the like of an object. The object recognition device 16 outputs results of the recognition to the automated driving control device 100. The object recognition device 16 may directly output detection results acquired by the camera 10, the radar device 12, and the LIDAR 14 to the automated driving control device 100. The object recognition device 16 may be omitted from the vehicle system 1.

The communication device 20, for example, communicates with other vehicles present in the vicinity of the subject vehicle M using a cellular network, a Wi-Fi network, Bluetooth (registered trademark), dedicated short range communication (DSRC), or the like or communicates with various server apparatuses through a radio base station.

The HMI 30 presents various types of information to an occupant of the subject vehicle M and receives an input operation performed by a vehicle occupant. The HMI includes various display devices, a speaker, a buzzer, a touch panel, switches, keys, and the like.

The vehicle sensor 40 includes a vehicle speed sensor that detects a speed of the subject vehicle M, an acceleration sensor that detects an acceleration, a yaw rate sensor that detects an angular velocity around a vertical axis, an azimuth sensor that detects the azimuth of the subject vehicle M, and the like.

The navigation device 50, for example, includes a global navigation satellite system (GNSS) receiver 51, a navigation HMI 52, and a path determining unit 53. The navigation device 50 stores first map information 54 in a storage device such as an HDD or a flash memory. The GNSS receiver 51 identifies a position of the subject vehicle M on the basis of signals received from GNSS satellites. The position of the subject vehicle M may be identified or complemented using an inertial navigation system (INS) that uses the output of the vehicle sensor 40. The navigation HMI 52 includes a display device, a speaker, a touch panel, a key, and the like. The navigation HMI 52 may be configured to be partially or entirely common as the HMI 30 described above. The path determining unit 53, for example, determines a path from a position of the subject vehicle M identified by the GNSS receiver 51 (or an input arbitrary position) to a destination input by a vehicle occupant using the navigation HMI 52 (hereinafter referred to as a path on a map) by referring to the first map information 54. The first map information 54, for example, is information in which a road form is represented using respective links representing roads and respective nodes connected using the links. The first map information 54 may include a curvature of each road, point of interest (POI) information, and the like. The path on the map is output to the MPU 60. The navigation device 50 may perform path guide using the navigation HMI 52 on the basis of the path on the map. The navigation device 50, for example, may be realized using a function of a terminal device such as a smartphone, a tablet terminal, or the like held by the vehicle occupant. The navigation device 50 may transmit a current position and a destination to a navigation server through the communication device 20 and acquire a path equivalent to the path on the map from the navigation server.

The MPU 60, for example, includes a recommended lane determining unit 61 and stores second map information 62 in a storage device such as an HDD or a flash memory. The recommended lane determining unit 61 divides the path on the map provided from the navigation device 50 into a plurality of blocks (for example, divides the path into blocks of 100 [m] in the traveling direction of the vehicle) and determines a recommended lane for each block by referring to the second map information 62. The recommended lane determining unit 61 determines in which of lanes numbered from the left side to travel. In a case in which there is a branching place in the path on the map, the recommended lane determining unit 61 determines a recommended lane such that the subject vehicle M can travel along a reasonable path for advancement to a branching destination.

The second map information 62 is map information having higher accuracy than the first map information 54. The second map information 62, for example, includes information on the centers of respective lanes or information on boundaries between lanes and the like. In addition, in the second map information 62, road information, traffic regulation information, address information (addresses and postal codes), facility information, telephone number information, information of prohibition sections in which a mode A or a mode B to be described below is prohibited, and the like may be included. In addition, in this embodiment, the second map information 62 is assumed to store curvature information in association with each place configuring a boundary of lanes (that is, a left road partition line and a right road partition line). The second map information 62 may be updated as needed by the communication device 20 communicating with another device.

The driver monitor camera 70, for example, is a digital camera using solid-state imaging elements such as a CCD or a CMOS. The driver monitor camera 70 is mounted at an arbitrary place in the subject vehicle M in such a position and a direction that a head part of a vehicle occupant sitting on a driver seat of the subject vehicle M (hereinafter referred to as a driver) can be imaged in front (in a direction in which a face is imaged). For example, the driver monitor camera 70 is mounted above a display device disposed at the center of an instrument panel of the subject vehicle M.

The driving operator 80, for example, includes an acceleration pedal, a brake pedal, a shift lever, and other operators in addition to the steering wheel 82. A sensor detecting the amount of an operation or the presence/absence of an operation is mounted in the driving operator 80, and a result of detection thereof is output to the automated driving control device 100 or some of all of the traveling driving force output device 200, the brake device 210, and the steering device 220. The steering wheel 82 is one example of “an operator that accepts a driver's steering operation”. The operator does not necessarily need to be in a circular form and may be in the form of a variant steering wheel, a joystick, a button, or the like. A steering grasp sensor 84 is mounted in the steering wheel 82. The steering grasp sensor 84 is realized by a capacitive sensor or the like and outputs a signal that can be used for detecting whether or not a driver is grasping the steering wheel 82 (this represents that the driver is contacting the steering wheel in the state of adding a force thereto) to the automated driving control device 100.

The automated driving control device 100, for example, includes a first control unit 120 and a second control unit 160. Each of the first control unit 120 and the second control unit 160, for example, is realized by a hardware processor such as a central processing unit (CPU) executing a program (software). Some or all of such constituent elements may be realized by hardware (a circuit unit; includes circuitry) such as a large scale integration (LSI), an application specific integrated circuit (ASIC), a field-programmable gate array (FPGA), a graphics processing unit (GPU), a system on chip (SOC) or the like or may be realized by software and hardware in cooperation. The program may be stored in a storage device (a storage device including a non-transitory storage medium) such as an HDD, a flash memory, or the like of the automated driving control device 100 in advance or may be stored in a storage medium such as a DVD or a CD-ROM that can be loaded or unloaded and mounted in the HDD or the flash memory of the automated driving control device 100 by loading the storage medium (a non-transitory storage medium) into a drive device. The automated driving control device 100 including a judgment unit 132 to be described below is one example of “vehicle control device”.

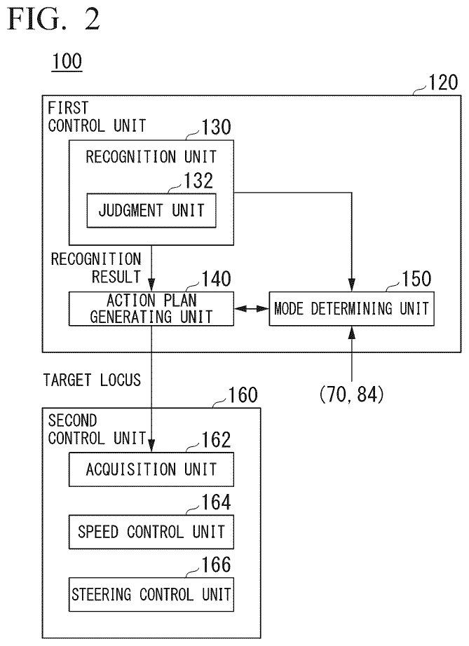

FIG. 2 is a functional configuration diagram of the first control unit 120 and the second control unit 160. The first control unit 120, for example, includes a recognition unit 130, a judgment unit 132, an action plan generating unit 140, and a mode determining unit 150. The first control unit 120, for example, simultaneously realizes functions using artificial intelligence (AI) and functions using a model provided in advance. For example, a function of “recognizing an intersection” may be realized by executing recognition of an intersection using deep learning or the like and recognition based on conditions given in advance (there are a signal, a road marking, and the like that can be used for pattern matching) at the same time and comprehensively evaluating both recognitions by assigning scores to them. Accordingly, the reliability of automated driving is secured.

The recognition unit 130 recognizes states such as positions, speeds, and accelerations of objects present in the vicinity of the subject vehicle M on the basis of information input from the camera 10, the radar device 12, and the LIDAR 14 through the object recognition device 16. A position of an object, for example, is recognized as a position in an absolute coordinate system having a representative point (the center of gravity, a drive axis center, or the like) of the subject vehicle M as its origin and is used for control. The position of an object may be represented as a representative point such as the center of gravity, a corner, or the like of the object or may be represented using an area. A “state” of an object may include an acceleration and a jerk of the object or an “action state” (for example, the object is performing lane change or is to perform lane change).

The recognition unit 130, for example, recognizes a lane (traveling lane) in which a subject vehicle M is traveling. For example, by comparing a pattern of a road partition line (hereinafter, it may be referred to as a “map road partition line”) acquired from the second map information 62 with a pattern of a road partition line (hereinafter, it may be referred to as a “camera road partition line”) in the vicinity of a subject vehicle M recognized from an image captured by the camera 10, the recognition unit 130 recognizes a traveling lane. More specifically, the recognition unit 130, for example, calculates a deviation between the map road partition line and the camera road partition line and, in a case in which it is judged that the calculated deviation is a threshold or less (in other words, in a case in which it is judged that they coincide with each other), recognizes one of the map road partition line and the camera road partition line (or a center line thereof or the like) as a traveling lane. The recognition unit 130 may recognize a traveling lane by recognizing traveling road boundaries (road boundaries) including road partition lines, road shoulders, curbstones, a median strip, guard rails, and the like instead of road partition lines. In this recognition, the location of the subject vehicle M acquired from the navigation device 50 or a processing result acquired by the INS may be taken into account as well. The recognition unit 130 recognizes a temporary stop line, an obstacle, a red signal, a toll gate, and other road events.

When recognizing a traveling lane, the recognition unit 130 recognizes a position and a posture of the subject vehicle M with respect to the traveling lane. The recognition unit 130, for example, may recognize a deviation of a reference point of the subject vehicle M from the center of the lane and an angle formed with respect to a line in which the center of the lane in the traveling direction of the subject vehicle M is aligned as a relative position and a posture of the subject vehicle M with respect to the traveling lane. Instead of this, the recognition unit 130 may recognize the position of the reference point of the subject vehicle M with respect to one side end part (a road partition line or a road boundary) of the traveling lane or the like as a relative position of the subject vehicle M with respect to the traveling lane.

The judgment unit 132 of the recognition unit 130 acquires map road partition lines present within a predetermined range (for example, within several hundreds of meters) from the current place of the subject vehicle M in the traveling direction and judges whether or not the acquired map road partition lines represent an “S”-shaped curved road. Details of the process performed by the judgment unit 132 will be described below.

The action plan generating unit 140 basically travels in a recommended lane determined by the recommended lane determining unit 61 and further generates a target locus along which the vehicle M will automatedly travel (travel without being dependent on a driver's operation) in the future such that approach to objects (excluding objects such as road partition lines, road signs, and manholes that can be passed over) recognized by the recognition unit 130 are avoided. For example, the recognition unit 130 sets a risk area having an object of which the state has been output as its center, and, inside the risk area, a risk is set as an index value representing a degree of avoidance of approach of the subject vehicle M by the recognition unit 130. The action plan generating unit 140 generates a target locus such that the subject vehicle M does not pass through a place of which the risk is a predetermined value or more and travels inside a recognized traveling lane. Since moving objects are included in objects, distributions of risks instead of one distribution of the risks are set for a plurality of time points in the future with future positions of objects predicted on the basis of speeds of the objects taken into account for each control cycle. For example, the target locus is represented as a sequence of places (locus points) at which the subject vehicle M will arrive. A locus point is a place at which the subject vehicle M will arrive at respective predetermined traveling distances (for example, about every several [m]) as distances along the road, and separately from that, a target speed and a target acceleration for each of predetermined sampling times (for example, a fraction of a [sec]) are generated as a part of the target locus. A locus point may be a position at which the subject vehicle M will arrive at a sampling time for every predetermined sampling time. In such a case, information of a target speed and a target acceleration is represented at the interval of locus points.

In generating a target locus, the action plan generating unit 140 may set events of automated driving. As events of automated driving, there are a constant-speed traveling event, a curved-road traveling event (an “S”-shaped curved-road traveling event), a low-speed following traveling event, a lane change event, a branching event, a merging event, a take-over event, and the like. The action plan generating unit 140 generates a target locus according to the operated events. For example, in a case in which presence of a curved road has been recognized by the recognition unit 130 as a curved-road traveling event on the basis of camera road partition lines or map road partition lines present in the traveling direction of the subject vehicle M, the action plan generating unit 140 generates a target locus such that the subject vehicle M is decelerated more than in a case in which presence of a curved road has not been recognized (for example, in a case in which a straight road has been recognized). In addition, for example, in a case in which it is judged that map road partition lines present in the traveling direction of the subject vehicle M represent an “S”-shaped curved road by the judgment unit 132 to be described below as an “S”-shaped curved-road traveling event, the action plan generating unit 140 generates a target locus such that the subject vehicle M is decelerated more than in a case in which map road partition lines do not represent an “S”-shaped curved road. Since the “S”-shaped curved road is one type of curved road, the “S”-shaped curved-road traveling event may be included in a curved-road traveling event. Deceleration of the subject vehicle M according to recognition of an “S”-shaped curved road is one example of “traveling control of a vehicle according to a curved road”.

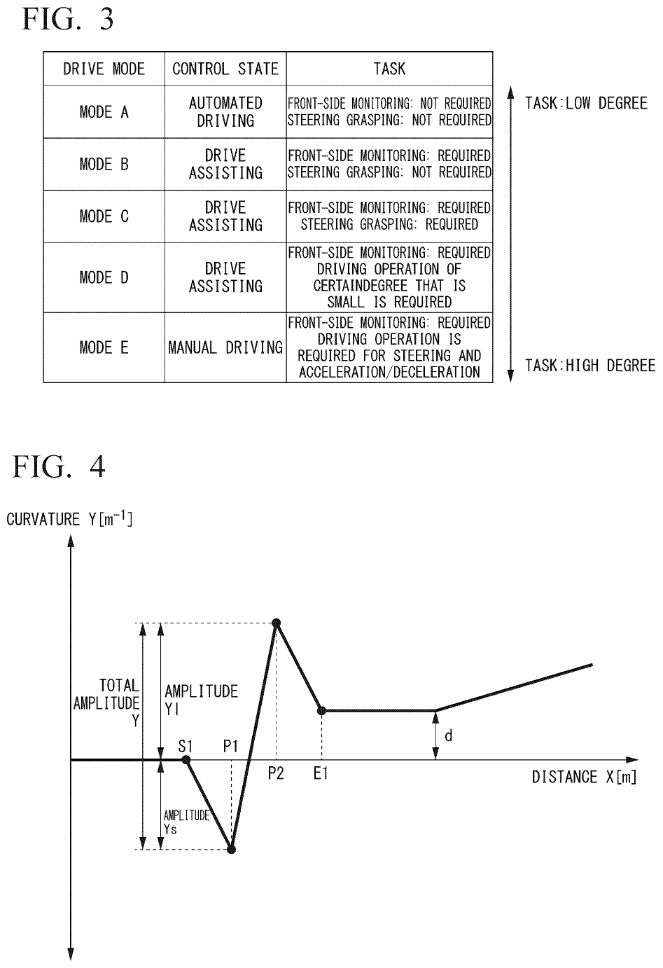

The mode determining unit 150 determines the drive mode of the subject vehicle M to be one of a plurality of drive modes in which tasks imposed on a driver are different. FIG. 3 is a diagram illustrating an example of a correspondence relation among a drive mode, a control state of a subject vehicle M, and a task. As drive modes of the subject vehicle M, for example, there are five modes including Mode A to Mode E. A control state, that is the degree of automation of driving control of the subject vehicle M is the highest in Mode A and is lowered in order of Mode B, Mode C, and Mode D after Mode A, and Mode E has a lowest control state. To the contrary, the degree of tasks imposed on a driver is the lowest in Mode A and becomes higher in order of Mode B, Mode C, and Mode D after Mode A, and the degree of Mode E is the highest. In Modes D and E, the control state is a state other than automated driving, and thus the automated driving control device 100 has a role of ending control relating to automated driving and transitioning to drive assistance or manual driving. Hereinafter, details of each drive mode will be described as an example.

In Mode A, an automated driving state is brought about, and both front-side monitoring and grasping of the steering wheel 82 (steering wheel grasping in the drawing) are not imposed on a driver. However, even in Mode A, the driver needs to have a posture of the body that can be quickly transitioned to manual driving in response to a request from a system having the automated driving control device 100 as the center. The automated driving described here means that all the steering and acceleration/deceleration are controlled without being dependent on a driver's operation. Here, a front side means a space in the traveling direction of the subject vehicle M that is visually recognized through a front windshield. Mode A, for example, is a mode that can be executed in a case in which conditions such as the subject vehicle M traveling at a speed equal to or lower than a predetermined speed (for example, about 50 [km/h]) on a motorway such as an expressway and a preceding vehicle that is a following target being present are satisfied and may be referred to as a traffic jam pilot (TJP). In a case in which such conditions are not satisfied, the mode determining unit 150 changes the drive mode of the subject vehicle M to Mode B.

In Mode B, a drive assisting state is formed, a task of monitoring the front side of the subject vehicle M (hereinafter referred to as front-side monitoring) is imposed on the driver, and a task of grasping the steering wheel 82 is not imposed. In Mode C, a drive assisting state is formed, and the task of front-side monitoring and the task of grasping the steering wheel 82 are imposed on the driver. Mode D is a drive mode in which a driver's driving operation of a certain degree is necessary for at least one of steering and acceleration/deceleration of the subject vehicle M. For example, in Mode D, drive assistance such as adaptive cruise control (ACC) and a lane keeping assist system (LKAS) is performed. In Mode E, a manual driving state in which driver's driving operations are necessary for both steering and acceleration/deceleration is formed. In both Mode D and Mode E, naturally, the task of monitoring the front side of the subject vehicle M is imposed on the driver.

The drive modes are not limited to those illustrated in FIG. 3 and may be defined using other definitions. For example, in drive modes required for forward monitoring and steering wheel grasping, there may be a drive mode having a loose threshold for judging that the steering wheel is grasped and a drive mode having a strict threshold for the judgment. More specifically, the drive modes may be defined such that, in a certain drive mode, a driver's left or right hand needs to only touch the steering wheel 82, and, in another drive mode in which heavier tasks are imposed on a driver, a driver needs to grip the steering wheel 82 using both hands with a strength of a threshold or more. Other drive modes with different severities of task imposed on the driver may be defined in any way.

The automated driving control device 100 (and a drive assisting device (not illustrated)) performs an automated lane change according to a drive mode. As automated lane changes, there are an automated lane change (1) according to a system request and an automated lane change (2) according to a driver's request. As the automated lane change (1), there are an automated lane change for overtaking that is performed in a case in which the speed of a preceding vehicle is lower than the speed of the subject vehicle by a reference or more and an automated lane change for traveling toward a destination (an automated lane change according to a change of a recommended lane). In the automated lane change (2), in a case in which conditions relating to a speed, a positional relation with a surrounding vehicle, and the like are satisfied, when a direction indictor is operated by a driver, the subject vehicle M is caused to change lane in a direction of the operation.

The automated driving control device 100 performs both the automated lane changes (1) and (2) in Mode A. The automated driving control device 100 performs either the automated lane changes (1) and (2) in Modes B and C. The drive assisting device (not illustrated) performs the automated lane change (2) without performing the automated lane change (1) in Mode D. None of both automated lane changes (1) and (2) is performed in Mode E.

In a case in which a task relating to the determined drive mode (hereinafter referred to as a current drive mode) is not performed by a driver, the mode determining unit 150 changes the drive mode of the subject vehicle M to a drive mode of which tasks have a higher degree of severity.

For example, in a case in which a driver has a posture of the body in which a transition to manual driving cannot be performed in accordance with a request from the system (for example, in a case in which the driver continues to look away outside an allowed area or in a case in which a sign making it difficult to perform driving is detected) in Mode A, the mode determining unit 150 performs control of prompting the driver to make a transition to manual driving using the HMI 30 and gradually stopping the subject vehicle M and pulling over and stopping the automated driving in a case in which the driver does not respond. After the automated driving is stopped, the subject vehicle comes into the state of Mode D or E, and the subject vehicle M can be started by a driver's manual driving. Hereinafter, this similarly applies to “stopping of automated driving”. In a case in which a driver is not monitoring the front side in Mode B, the mode determining unit 150 performs control of prompting the driver to monitor the front side using the HMI 30 and gradually stopping the subject vehicle M to be pulled over and stopping the automated driving in a case in which the driver does not respond. In a case in which the driver is not monitoring the front side or in a case in which the driver is not grasping the steering wheel 82 in Mode C, the mode determining unit 150 performs control of prompting the driver to monitor the front side using the HMI 30 and/or grasp the steering wheel 82 and gradually stopping the subject vehicle M to be pulled over and stopping the automated driving in a case in which the driver does not respond.

In addition, in order to change the mode, the mode determining unit 150 monitors the state of the driver and judges whether or not the state of the driver is a state according to the task. For example, the mode determining unit 150 performs a posture estimating process by analyzing an image captured by the driver monitor camera 70 and judges whether or not the driver has a posture of the body in which a transition to manual driving cannot be performed in response to a request from the system. The driver state judging unit 152 performs a visual line estimating process by analyzing the image captured by the driver monitor camera 70 and judges whether or not the driver is monitoring the front side.

In addition, in this embodiment, in a case in which it has been judged by the judgment unit 132 that map road partition lines present in the traveling direction of the subject vehicle M represents an “S”-shaped curved road, the mode determining unit 150 changes the drive mode of the subject vehicle M to a drive mode of which a task has a higher degree of severity. For example, in a case in which it has been judged that map road partition lines present in the traveling direction of the subject vehicle M represent an “S”-shaped curved road while the subject vehicle M is traveling in a drive mode (Mode A or Mode B) not requiring steering grasping, the mode determining unit 150 changes the drive mode to a mode that is Mode C or less (Mode C, Mode D, or Mode E). “Changing the drive mode of the subject vehicle M to a drive mode of which a task has a higher degree of severity” is one example of “vehicle traveling control according to a curved road”.

The mode determining unit 150 performs various processes for changing the mode. For example, the mode determining unit 150 instructs the action plan generating unit 140 to generate a target locus for stopping on the road shoulder, instructs the drive assisting device (not illustrated) to operate, or controls the HMI 30 for prompting the driver to perform an action.

The second control unit 160 performs control of the traveling driving force output device 200, the brake device 210, and the steering device 220 such that the subject vehicle M passes through the target locus generated by the action plan generating unit 140 at a scheduled time.

Referring back to FIG. 2, the second control unit 160, for example, includes an acquisition unit 162, a speed control unit 164, and a steering control unit 166. The acquisition unit 162 acquires information of a target locus (locus points) generated by the action plan generating unit 140 and stores the acquired target locus in a memory (not illustrated). The speed control unit 164 controls the traveling driving force output device 200 or the brake device 210 on the basis of speed elements accompanying the target locus stored in the memory. The steering control unit 166 controls the steering device 220 in accordance with a bending state of the target locus stored in the memory. The processes of the speed control unit 164 and the steering control unit 166, for example, are realized by a combination of feed-forward control and feedback control. As one example, the steering control unit 166 executes feed-forward control according to a curvature of a road disposed in front of the subject vehicle M and feedback control based on a deviation from a target locus in combination.

The traveling driving force output device 200 outputs a traveling driving force (torque) for enabling the vehicle to travel to driving wheels. The traveling driving force output device 200, for example, includes a combination of an internal combustion engine, an electric motor, and a transmission, and an electronic control unit (ECU) controlling these. The ECU controls the components described above in accordance with information input from the second control unit 160 or information input from the driving operator 80.

The brake device 210, for example, includes a brake caliper, a cylinder that delivers hydraulic pressure to the brake caliper, an electric motor that generates hydraulic pressure in the cylinder, and a brake ECU. The brake ECU performs control of the electric motor in accordance with information input from the second control unit 160 or information input from the driving operator 80 such that a brake torque according to a brake operation is output to each vehicle wheel. The brake device 210 may include a mechanism delivering hydraulic pressure generated in accordance with an operation on the brake pedal included in the driving operators 80 to the cylinder through a master cylinder as a backup. The brake device 210 is not limited to the configuration described above and may be an electronically-controlled hydraulic brake device that delivers hydraulic pressure in the master cylinder to a cylinder by controlling an actuator in accordance with information input from the second control unit 160.

The steering device 220, for example, includes a steering ECU and an electric motor. The electric motor, for example, changes the direction of the steering wheel by applying a force to a rack and pinion mechanism. The steering ECU changes the direction of the steering wheel by driving an electric motor in accordance with information input from the second control unit 160 or information input from the driving operator 80.

### [Process of Judging “S”-Shaped Curved Road]

As described above, the judgment unit 132 judges whether or not map road partition lines present in the traveling direction of the subject vehicle M represent an “S”-shaped curved road, and, in a case in which it is judged that the map road partition lines represent an “S”-shaped curved road, the first control unit 120 executes traveling control of the vehicle according to a curved road. However, in a conventional technology, for example, there are cases in which misrecognition of map road partition lines occurs while the subject vehicle M is traveling on a straight road, and map road partition lines to be originally recognized as a straight road is recognized as an “S”-shaped curved road. As a result, traveling control corresponding to a curved road is applied to the subject vehicle M traveling through automated driving or drive assistance, and there are cases in which inappropriate deceleration control is executed even though the subject vehicle is traveling on a straight road.

On the background of such situations, the judgment unit 132, first, extracts an “S”-shaped curved road candidate from map road partition lines present in the traveling direction of the subject vehicle M and judges whether or not the extracted “S”-shaped curved road candidate is noise. In a case in which it is judged that the “S”-shaped curved road candidate is noise by the judgment unit 132, the first control unit 120 continues the automated driving or the drive assistance of the subject vehicle M without lowering the level of the drive mode of the subject vehicle M and executing deceleration control. Hereinafter, the judgment process executed by the judgment unit 132 will be described.

FIG. 4 is a diagram illustrating conditions for the judgment unit 132 to extract an “S”-shaped curved road candidate. A graph illustrated in FIG. 4 represents a relation between a distance X [m] from the subject vehicle M and a curvature Y [m−1] at each place configuring a map road partition line for the map road partition line present in the traveling direction of the subject vehicle M. Although FIG. 4 illustrates a case in which the map road partition line bends clockwise in a case in which the curvature Y has a positive value, and the map road partition line bends counterclockwise in a case in which the curvature Y has a negative value, this sign relation may be reversed. The judgment unit 132 judges whether or not a map road partition line in a predetermined range present in the traveling direction of the subject vehicle M satisfies all Condition 1 to Condition 6 (or an arbitrary combination including at least one condition) for extracting an “S”-shaped curved road candidate and, in a case in which it is judged that the map road partition line satisfies these conditions, extracts this map road partition line as an “S”-shaped curved road candidate.

The judgment unit 132 judges whether or not the signs of consecutive peak points are reversed for the curvature of the map road partition line as Condition 1. This condition is a condition for judging whether or not, after the map road partition line initially bends to one side (the right side or the left side), next, it bends to the other side (the left side or the right side) as an “S”-shaped curved road. In the example illustrated in FIG. 4, the graph includes a peak point P1 and a peak point P2, and the signs of the consecutive peak points P1 and P2 are reversed. Thus, the judgment unit 132 judges that the graph illustrated in FIG. 4 satisfies Condition 1.

In addition, the judgment unit 132 judges whether or not a distance between consecutive peak points is a predetermined value or less as Condition 2. This condition is a condition for judging whether or not a map road partition line has a sufficiently small distance between peak points that is appropriate for being judged as an “S” curved road. In the case of FIG. 4, the judgment unit 132 judges whether or not the distance between the peak point P1 and the peak point P2 is a predetermined value or less.

Furthermore, the judgment unit 132 judges whether or not a total amplitude Y that is a sum of the amplitude Yl of the peak point P1 and the amplitude Ys of the peak point P2 is a predetermined value or more as Condition 3. This condition is a condition for judging whether the map road partition line has a sufficiently large degree of bending that is appropriate for being judged as an “S”-shaped curved road.

In addition, the judgment unit 132 judges whether or not an amplitude ratio Yl/Ys of the amplitude Yl of the peak point P2 to the amplitude Ys of the peak point P1 is a predetermined value (here, the predetermined value is assumed to be a value that is one or more) or more as Condition 4. Generally, the amplitude of a next peak point P2 tends to be larger than the amplitude of an initial peak point P1 on an “S”-curved road, and thus, this condition is a condition for judging whether or not the map road partition line has this tendency.

Furthermore, the judgment unit 132 judges whether or not the amplitude Yl of the peak point P2 is a predetermined value or more as Condition 5. This condition is a condition for judging whether the map road partition line has a sufficiently large amplitude Yl of the peak point P2 that is appropriate for being judged as an “S”-shaped curved road.

Furthermore, as Condition 6, the judgment unit 132 judges whether or not a curvature difference d between a start point S1 and an end point E1 of a section of the map road partition line including two peak points P1 and P2 of which signs of the curvatures are reversed is a predetermined value or less. This condition is a condition for determining a front end and a terminal end of an “S”-shaped curved road in the map road partition line. In other words, first, after determining a start point S1 at which the curvature starts to change in the map road partition line, the judgment unit 132 may define a point that is a place in a section of the map road partition line including two peak points P1 and P2 of which signs of curvatures are reversed and is a place at which a curvature difference d from the start point S1 becomes a predetermined value or less for the first time as an end point E1.

In this way, the judgment unit 132 extracts a partition satisfying all the above-described Condition 1 to Condition 6 (or an arbitrary combination including at least one condition) from a map road partition line present in the traveling direction of the subject vehicle M as an “S”-shaped curved road candidate. When the “S”-shaped curved road candidate is extracted, the judgment unit 132, next, judges whether or not this “S”-shaped curved road candidate is noise.

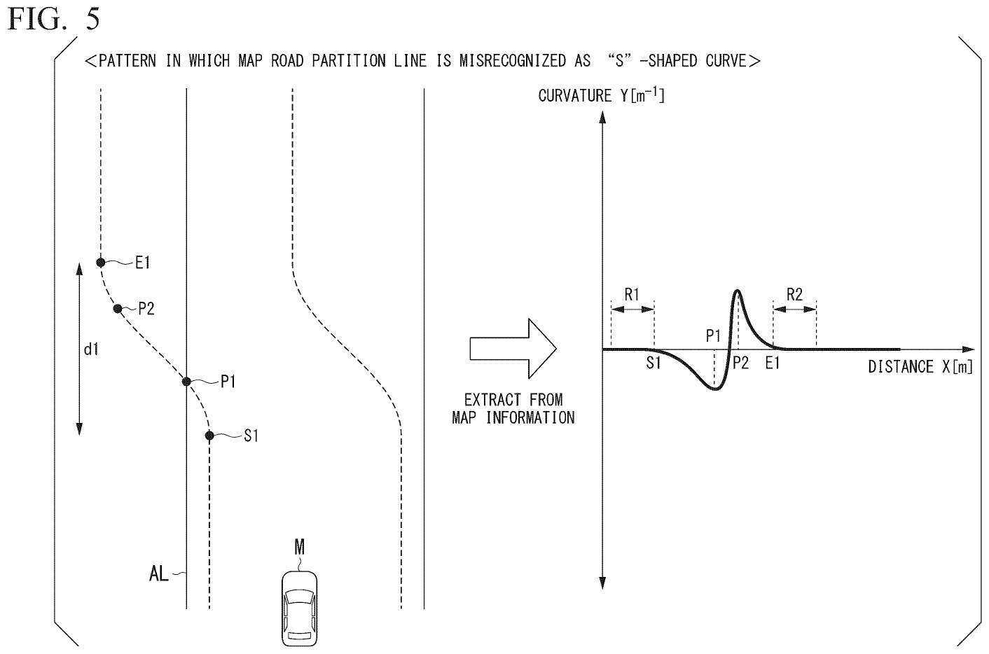

FIG. 5 is a diagram illustrating a method of judging an “S”-shaped curved road candidate as noise using the judgment unit 132. In FIG. 5, a solid line Al represents an actual road, and a dotted line ML represents a map road partition line. In other words, FIG. 5 illustrates a situation in which, even when the subject vehicle M is actually traveling on a straight road, a map road partition line is misrecognized as an “S”-shaped curved road. It is assumed that the judgment unit 132 extracts a section from the start point S1 to the end point E1 in the map road partition line as an “S”-shaped curved road candidate.

When an “S”-shaped curved road candidate is extracted, the judgment unit 132 judges whether or not the extracted “S”-shaped curved road candidate is noise as the first condition of noise judgment. More specifically, the judgment unit 132, first, judges whether or not a distance d1 from the start point S1 to the end point E1 in the “S”-shaped curved road candidate is a first threshold or less. This condition is a condition for judging whether the extracted “S”-shaped curved road candidate has an unrealistic (too short) distance as an “S”-shaped curved road. In other words, in a case in which the distance d1 is the first threshold or less, it means that this “S”-shaped curved road candidate has a short distance for traveling of an actual vehicle and has a high possibility of being noise.

Next, the judgment unit 132 judges whether or not an amount of curvature change of at least one of a front range and a rear range of the extracted “S”-shaped curved road candidate is a second threshold or less as the second condition of the noise judgment. In the case of FIG. 5, the judgment unit 132 judges whether or not an amount of curvature change of at least one (or both) of a first range R1 that is apart from the start point S1 of the “S”-shaped curved road candidate to the rear side in the traveling direction by a predetermined distance and a second range R2 apart from the end point E1 of the “S”-shaped curved road candidate to the front side in the traveling direction by a predetermined distance is a second threshold or less. This condition is a condition for judging whether or not the extracted “S”-shaped curved road candidate has an unrealistic (normal) amount of curvature change in the forward/backward direction as an “S”-shaped curved road. In other words, in a case in which the “S”-shaped curved road candidate is an actual “S”-shaped curved road, generally, this “S”-shaped curved road has an amount of curvature change that tends to larger than the second threshold in at least one (or both) of forward/backward directions, and thus, it means that this “S”-shaped curved road candidate has a high possibility of being noise in a case in which the amount of curvature change is the second threshold or less. A condition of whether or not the amount of curvature change of at least one (or both) of the first range R1 and the second range R2 is the second threshold or less can be also expressed as a condition of whether or not at least one (or both) of the first range R1 and the second range R2 has a normal shape without any change in the road shape, more specifically, whether or not it is a straight road or a normal curved road.

In this way, the judgment unit 132 judges whether or not the extracted “S”-shaped curved road candidate satisfies the first condition and the second condition of the noise judgment and, in a case in which it is judged that the “S”-shaped curved road candidate satisfies the first condition and the second condition, judges that this “S”-shaped curved road candidate is noise. In the case of FIG. 5, the judgment unit 132 judges that the distance d1 is the first threshold or less and judges that the amount of curvature change in both of the first range R1 and the second range R2 is the second threshold or less and thus judges the extracted “S”-shaped curved road candidate as noise. Alternatively, the judgment unit 132 judges whether or not the “S”-shaped curved road candidate satisfies at least one of the first condition and the second condition and, in a case in which it is judged that the “S”-shaped curved road candidate satisfies at least one of the first condition and the second condition, may judge that this “S”-shaped curved road candidate is noise.

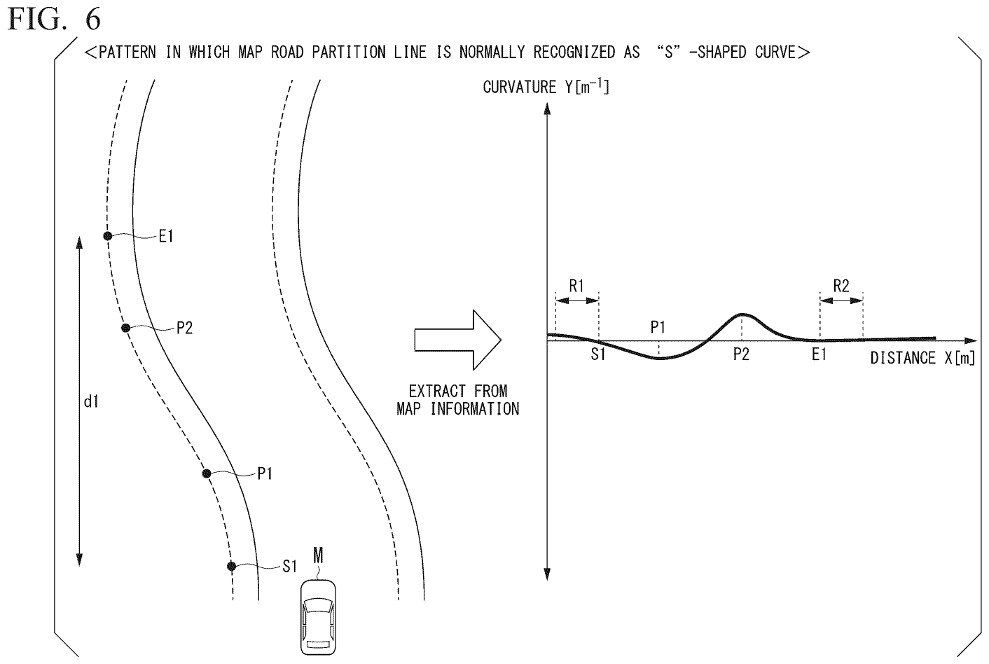

FIG. 6 is a diagram illustrating a method of normally judging an “S”-shaped curved road candidate as an “S”-shaped curved road using the judgment unit 132. FIG. 6 is a diagram illustrating a situation in which the subject vehicle M is actually traveling on an “S”-shaped curved road. Different from the case of FIG. 5, in the situation illustrated in FIG. 6, the judgment unit 132 judges that a distance d1 from a start point S1 to an end point E1 in the “S”-shaped curved road candidate is larger than the first threshold, judges that the amount of curvature change in both of the first range R1 and the second range R2 is larger than the second threshold, and thus judges that the extracted “S”-shaped curved road candidate is a normal “S”-shaped curved road.

In a case in which it is judged by the judgment unit 132 that the “S”-shaped curved road candidate is noise, as described above, the first control unit 120 continues automated driving or drive assistance of the subject vehicle M before judgment without lowering the level of the drive mode of the subject vehicle M or executing deceleration control according to a curved road. At this time, the first control unit 120 may perform traveling control such that the subject vehicle M goes straight or perform traveling control according to the end point E1 of the “S”-shaped curved road candidate or a start point of a road following this end point E1. For example, the first control unit 120 may perform traveling control of the subject vehicle M such that the subject vehicle M goes straight from a current place of the subject vehicle M to the end point E1 of the “S”-shaped curved road candidate or a start point of a road following this end point E1. In addition, as another aspect, the action plan generating unit 140 may generate a target locus such that the subject vehicle M passes through a predicted place on the premise of a speed and an acceleration of the subject vehicle M before judgment on the basis of odometry information (a speed, an acceleration, and the like) of the subject vehicle M.

### [Process Flow]

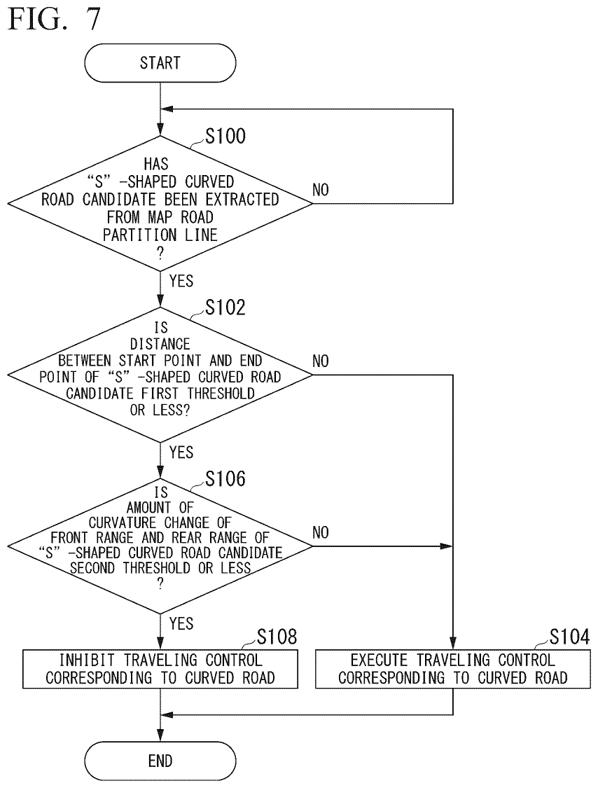

Next, the flow of a process executed by the automated driving control device 100 will be described with reference to FIG. 7. FIG. 7 is a flowchart illustrating one example of the flow of a process executed by the automated driving control device 100. The process illustrated in the flowchart of FIG. 7 is repeatedly executed by the automated driving control device 100 while the subject vehicle M is traveling in a drive mode in which automated driving or drive assistance is executed.

The judgment unit 132, first, judges whether or not an “S”-shaped curved road candidate has been extracted from map road partition lines present in the traveling direction of the subject vehicle M (Step S100). More specifically, the judgment unit 132 judges whether or not a map road partition line present in the traveling direction of the subject vehicle M satisfies all the Condition 1 to Condition 6 (or an arbitrary combination including at least one condition) for extracting an “S”-shaped curved road candidate.

In a case in which it is judged that an “S”-shaped curved road candidate has not been extracted, the judgment unit 132, after a predetermined period, executes the process of Step S100 again. On the other hand, in a case in which it is judged that an “S”-shaped curved road candidate has been extracted, the judgment unit 132, next, judges whether or not a distance between a start point and an end point of the extracted “S”-shaped curved road candidate is the first threshold or less (Step S102). In a case in which it is judged that the distance between the start point and the end point of the extracted “S”-shaped curved road candidate is larger than the first threshold, the first control unit 120 executes traveling control corresponding to a curved road (Step S104). More specifically, the action plan generating unit 140 generates a target locus to decelerate the subject vehicle M, and the mode determining unit 150 changes the drive mode of the subject vehicle M to a drive mode of which a task has a higher degree of severity.

On the other hand, in a case in which it is judged that the distance between the start point and the end point of the extracted “S”-shaped curved road candidate is the first threshold or less, the judgment unit 132, next, judges whether or not the amount of curvature change of the front range and the rear range of the “S”-shaped curved road candidate is the second threshold or less (Step S106). In a case in which it is judged that the amount of curvature change of the front range and the rear range of the “S”-shaped curved road candidate is larger than the second threshold, the first control unit 120 executes traveling control corresponding to a curved road (Step S104). On the other hand, in a case in which it is judged that the amount of curvature change of the front range and the rear range of the “S”-shaped curved road candidate is the second threshold or less, the first control unit 120 executes traveling control corresponding to a curved road (Step S108). In accordance with this, the process of this flowchart ends.

In the description presented above, the judgment unit 132, first, extracts an “S”-shaped curved road candidate from map road partition lines on the basis of Condition 1 to Condition 6 for extracting an “S”-shaped curved road candidate and, next, judges whether the extracted “S”-shaped curved road candidate satisfies the first condition and the second condition of the noise judgment. However, the present invention is not limited to such a configuration, and the judgment unit 132 may search for a partition that simultaneously satisfies Condition 1 to Condition 6 for extracting an “S”-shaped curved road candidate from map road partition lines and the first condition and the second condition of the noise judgment.

According to this embodiment described above, in a case in which the distance between the start point and the end point of an “S”-shaped road candidate is the first threshold or less, the judgment unit judges that the “S”-shaped road candidate is not an “S”-shaped road, and, in a case in which it is judged that this “S”-shaped road candidate is not an “S” shaped road, the control unit inhibits traveling control of the vehicle corresponding to a curved road. In accordance with this, traveling control that is inappropriate to the subject vehicle can be prevented from being executed due to misrecognition of road partition lines recognized from the map information as an “S”-shaped curved road.

The embodiment described above can be represented as below.

A vehicle control device that includes a storage device storing a program a hardware processor and, by executing the program described above using the hardware processor described above, is configured to: judge whether or not an “S”-shaped road candidate that is a partition represented by map road partition lines based on map information stored in the storage unit represents an “S”-shaped road; perform traveling control of a vehicle on the basis of the map road partition lines; judge that the “S”-shaped road candidate is not an “S”-shaped road in a case in which a distance between a start point and an end point of the “S”-shaped road candidate described above is a first threshold or less; and inhibit traveling control of the above-described vehicle corresponding to a curved road in a case in which it is judged that the “S”-shaped road candidate described above is not an “S”-shaped road.

As above, although the embodiments have been described in forms for performing the present invention, the present invention is not limited to such embodiments at all, and various modifications and substitutions can be performed in a range not departing from the concept of the present invention.

What is claimed is:

1. A vehicle control device comprising:
a storage medium storing instructions that are able to be read by a computer; and
a processor connected to the storage medium,
wherein, by executing instructions that are able to be read by the computer, the processor:
judges whether or not an “S”-shaped road candidate that is a partition represented by map road partition lines based on map information stored in a storage unit represents an “S”-shaped road and performs traveling control of a vehicle on the basis of the map road partition lines,
wherein the processor judges that the “S”-shaped road candidate is not an “S” shaped road in a case in which a distance between a start point and an end point of the “S”-shaped road candidate is a first threshold or less, and
wherein the processor inhibits traveling control of the vehicle corresponding to a curved road in a case in which it is judged that the “S”-shaped road candidate is not an “S”-shaped road.

2. The vehicle control device according to claim 1, wherein the processor judges that the “S”-shaped road candidate is not an “S”-shaped road in a case in which the distance between the start point and the end point of the “S”-shaped road candidate is the first threshold or less, and an amount of curvature change of at least one of a front range and a rear range of the “S”-shaped road candidate is a second threshold or less.

3. The vehicle control device according to claim 1, wherein the processor judges that the “S”-shaped road candidate is not an “S”-shaped road in a case in which the distance between the start point and the end point of the “S”-shaped road candidate is the first threshold or less, and at least one of a front range and a rear range of the “S”-shaped road candidate is a straight line.

4. The vehicle control device according to claim 1, wherein the processor performs traveling control such that the vehicle goes straight in a case in which it is judged that the “S”-shaped road candidate is not an “S”-shaped road.

5. The vehicle control device according to claim 1, wherein, in a case in which it is judged that the “S”-shaped road candidate is not an “S”-shaped road, the processor continues the traveling control that has been performed before the judgment.

6. The vehicle control device according to claim 1, wherein, in a case in which it is judged that the “S”-shaped road candidate is not an “S”-shaped road, the processor performs traveling control corresponding to the end point of the “S”-shaped road candidate or a start point of a road following the “S”-shaped road candidate.

7. The vehicle control device according to claim 1, wherein, in a case in which it is judged that the “S”-shaped road candidate is not an “S”-shaped road, the processor does not execute curved-road deceleration control for the “S”-shaped road candidate.

8. A vehicle control method using a computer, the vehicle control method comprising:
judging whether or not an “S”-shaped road candidate that is a partition represented by map road partition lines based on map information stored in a storage unit represents an “S”-shaped road;
performing traveling control of a vehicle on the basis of the map road partition lines;
judging that the “S”-shaped road candidate is not an “S” shaped road in a case in which a distance between a start point and an end point of the “S”-shaped road candidate is a first threshold or less; and
inhibiting traveling control of the vehicle corresponding to a curved road in a case in which it is judged that the “S”-shaped road candidate is not an “S”-shaped road.

9. A computer-readable non-transitory storage medium storing a program causing a computer to:
judge whether or not an “S”-shaped road candidate that is a partition represented by map road partition lines based on map information stored in a storage unit represents an “S”-shaped road;
perform traveling control of a vehicle on the basis of the map road partition lines;
judge that the “S”-shaped road candidate is not an “S” shaped road in a case in which a distance between a start point and an end point of the “S”-shaped road candidate is a first threshold or less; and
inhibit traveling control of the vehicle corresponding to a curved road in a case in which it is judged that the “S”-shaped road candidate is not an “S”-shaped road.
